(19) United States
(12) Patent Application Publication
(10) Pub. No.: US 2021/0007387 A1
(43) Pub. Date: Jan. 14, 2021

(54) COATING MATERIAL FOR DEEP-FRIED FOOD

(71) Applicant: NICHIREI FOODS INC., Tokyo-to (JP)

(72) Inventors: Tomoki ABE, Chiba-shi (JP); Yuichi ISHIZAKI, Chiba-shi (JP)

(73) Assignee: NICHIREI FOODS INC., Tokyo-to (JP)

(21) Appl. No.: 17/037,123

(22) Filed: Sep. 29, 2020

Related U.S. Application Data
(63) Continuation of application No. PCT/JP2019/011637, filed on Mar. 20, 2019.

(30) Foreign Application Priority Data
Mar. 30, 2018 (JP) 2018-069221
Nov. 27, 2018 (JP) 2018-221611

(51) Int. Cl. A23P 20/10; A21D 13/60

(52) U.S. Cl. CPC A23P 20/10; A21D 13/60

(57) ABSTRACT

Disclosed is a batter for a deep-fried food product containing saccharide, cereal flour, and water, wherein in a deep-fried food product obtained by deep-frying a processed food product for deep-frying containing the batter for the deep-fried food product, the value of water activity of a coating layer including a heated batter layer derived from the batter for the deep-fried food product is 0.620 to 0.900. It is possible to retain an excellent texture of the coating in the deep-fried food product by use of this batter.

### CROSS REFERENCE TO RELATED APPLICATIONS

The present patent application claims priority based on Japanese Patent Application No. 2018-69221 (filing date of the application: Mar. 30, 2018) and Japanese Patent Application No. 2018-221611 (filing date of the application: Nov. 27, 2018) which are patent applications filed earlier in Japan. The whole discloses of these earlier patent applications are hereby incorporated by reference as a part of this description.

### BACKGROUND OF INVENTION

### Technical Field

The present invention relates to a coating material for use in a deep-fried food product and specifically relates to a batter.

### Background Art

When several hours has passed after cooking of deep-fried products having a coating and when such products after several hours of cooking are reheated before eating, retaining crisp feeling is an endless challenge. A saccharide (sugar alcohol, trehalose, or the like) has been conventionally added to a coating batter in order to improve and retain the crispness of deep-fried coated food products (Patent Literatures 1 and 2).

However, with the conventional arts, in the case where deep-fried foods, after deep-fried, are sold in a container such as a package having a lid and the like, due to a time lapse from the cooking to eating, the coating absorbs moisture from steam in the container or moisture coming out of the inner material. Thus, the texture of the coating is far from being favorable when such foods are eaten as they are or after heated in a microwave oven.

### PRIOR ART DOCUMENT

### Patent Document

### [Patent Document 1] JP 2008-295360 A

### [Patent Document 2] JP 2004-57041 A

### SUMMARY OF INVENTION

The present inventors have found that, when deep-fried food products are produced using a batter containing a saccharide, a cereal flour, and water, deterioration due to time lapse of the texture of the coating of the deep-fried food products is prevented by adjusting the value of water activity, within a specific range, of the coating layer containing a heated batter layer derived from the batter. The present invention is based on this finding.

Accordingly, it is an object of the present invention to provide a batter that retains an excellent texture of the coating in deep-fried food products, a processed food product for deep-frying containing the batter, and a deep-fried food product obtained by using the batter.

Then, the present invention encompasses the following aspects of the invention.

(1) A batter for a deep-fried food product comprising saccharide, cereal flour, and water, wherein in a deep-fried food product obtained by deep-frying a processed food product for deep-frying containing the batter for the deep-fried food product, the value of water activity of a coating layer containing a heated batter layer derived from the batter for the deep-fried food product is 0.620 to 0.900.
(2) The batter for a deep-fried food product according to (1), wherein a content percentage of the saccharide is 18 to 75% by mass, a content percentage of the cereal flour is 5 to 50% by mass, and a mass ratio of a content amount of the saccharide to a content amount of the water (saccharide/water) is 0.3 to 4.5.
(3) The batter for a deep-fried food product according to (1) or (2), wherein the saccharide is selected from the group consisting of monosaccharide, disaccharide, trisaccharide, tetrasaccharide, pentasaccharide, sugar alcohol, and dextrin.
(4) The batter for a deep-fried food product according to (1) or (2), wherein the saccharide is selected from the group consisting of monosaccharide, disaccharide, trisaccharide, tetrasaccharide, pentasaccharide, and dextrin.
(5) The batter for a deep-fried food product according to any one of (1) to (4), wherein the cereal flour is selected from the group consisting of starch, wheat flour, and corn flour.
(6) A processed food product for deep-frying comprising an inner material of an intended deep-fried food product, and a layer of the batter for the deep-fried food product according to any one of (1) to (5) located outside the inner material.
(7) The processed food product for deep-frying according to (6), wherein the processed food product is frozen.
(8) A method for producing a processed food product for deep-frying, comprising a step of batter processing, wherein the inner material of an intended deep-fried food product is processed with the batter for the deep-fried food product according to any one of (1) to (5).
(9) The method according to (8), further comprising a step of freezing, wherein the freezing step is conducted after the step of batter processing.
(10) A deep-fried food product comprising an inner material, and a heated batter layer derived from the batter for the deep-fried food product according to any one of (1) to (5) located outside the inner material.
(11) The deep-fried food product according to (10), wherein the deep-fried food product is frozen.
(12) A method for producing a deep-fried food product, comprising a step of deep-frying the processed food product for deep-frying according to (6) or (7).
(13) A method for producing a deep-fried food product, comprising a step of producing a processed food product for deep-frying by the method according to (8) or (9), and a step of deep-frying the processed food product for deep-frying.
(14) The method according to (12) or (13), further comprising a step of freezing, wherein the freezing step is conducted after the step of deep-frying.
(15) A batter for a deep-fried food product, wherein, in a deep-fried food product obtained by deep-frying a processed food product for deep-frying containing the batter for the deep-fried food product, the value of water activity of a coating layer containing a heated batter layer derived from the batter for the deep-fried food product is 0.620 to 0.900.
(16) A processed food product for deep-frying comprising an inner material of an intended deep-fried food product and a layer of a batter for the deep-fried food product located outside the inner material, wherein, in the deep-fried food product obtained by deep-frying the processed food product for deep-frying, the value of water activity of a coating layer containing a heated batter layer derived from the batter for the deep-fried food product is 0.620 to 0.900.
(17) A deep-fried food product comprising an inner material and a heated batter layer derived from a batter for the deep-fried food product located outside the inner material, wherein the value of water activity of a coating layer containing the heated batter layer is 0.620 to 0.900.

By using the batter of the present invention, it is possible to prevent deterioration over time in the texture of the deep-fried coating of deep-fried food products such as crispness and easiness of biting off and to retain crisp texture specific to such deep-fried coating, naturally when the food products are sold separately (in an open state) and even when such food products are put in a bag or container. Particularly, in accordance with the present invention, the crispness is retained even when such food products are reheated in a microwave oven after preservation. For example, in the case where a deep-fried food product, after deep-fried, is packed in a container such as a tray or bag and left to stand at normal temperature, the quality of a conventional product falls below the lower limit in about 3 hours (marked decrease in the crisp feeling). However, a deep-fried food product of the present invention can retain a crisp feeling comparable to the quality obtainable immediately after deep-frying, even after a lapse of 3 hours. Additionally, the deep-fried food product of the present invention does not lose the crispness even when reheated in a microwave oven after the lapse of 3 hours and therefore retains the crispness better than conventional deep-fried coated food products. Furthermore, in accordance with the present invention, it is also possible to provide a deep-fried food product that retains a moderately dried appearance specific to a deep-fried coating even when preserved for a long time after deep-frying and particularly that retains a moderately dried appearance even when reheated in a microwave oven after the preservation.

### BRIEF DESCRIPTION OF THE DRAWINGS

FIG. 1 shows photographs of a sample of test section 1 and a sample of test section 5 as a negative control, comparing appearance of the samples immediately and at 3-hour preservation in a package after deep-frying.

### DETAILED DESCRIPTION OF THE INVENTION

A batter of the present invention comprises a saccharide, a cereal flour, and water. When the batter of the present invention is used as a coating material for a deep-fried food product, in the deep-fried food product, a coating layer including a heated batter layer derived from the batter has a value of water activity of 0.620 to 0.900 and preferably of 0.620 to 0.860.

In the present invention, the “coating layer” means a coating portion contained in a deep-fried food product, being a portion forming a layer outside the inner material (ingredient). In other words, the coating layer is a portion, other than the inner material (ingredient), forming the deep-fried food product. For example, in the case where the deep-fried food product is produced using only an inner material and a batter, the coating layer is a heated batter layer. In the case where the deep-fried food product is produced using coating raw materials such as a dusting powder and bread crumbs in addition to the inner material and batter, the coating layer means not only the heated batter layer but also a heated layer derived from both the batter and the coating raw materials.

The value of water activity is a numerical value representing the ratio of free water in a food product and is commonly used as an indicator of the preservability of food products. The value of water activity can be measured as follows, for example. First, a coating material is attached to the surface of an inner material, which is deep-fried. Here, the coating material may be made of only a batter or of a batter and other coating raw materials as desired. The deep-fried food product obtained is frozen in a freezer at about −35° C. Then, the frozen product is deep-fried at 175° C. for 7 minutes. The deep-fried food product obtained is allowed to slightly cool while left at normal temperature, and the coating layer (the portion other than the inner material) is rapidly removed. Then, the coating layer removed is cut into small pieces to prevent a measurement bias. 3 to 3.5 g of the pieces are placed in a Petri dish, and a commercially available water activity measurement system is used to measure its water activity. The numerical value to be determined by this measurement can be taken as the value of water activity of the sample.

The batter of the present invention can be produced by introducing a saccharide, a cereal flour, and water in a mixing vessel and mixing the materials into a batter form. Here, the blending amount of each material can be determined by producing a deep-fried food product using various batters, measuring the value of water activity of the coating layer, and confirming that the value of water activity obtained is in the above numerical range.

The saccharide for use in the present invention may be any saccharide having a relatively short chain, among carbohydrate excluding polysaccharide such as starch, and dietary fiber, and is not particularly limited. Examples of such saccharide include monosaccharide or oligosaccharide. Preferably, monosaccharide, disaccharide, trisaccharide, tetrasaccharide, or pentasaccharide, more preferably, trehalose or glucose, and even more preferably, trehalose can be used. Examples of the saccharide can include dextrin. Preferably, dextrin having a DE of 20 to 4, more preferably, dextrin having a DE of 18 to 4, and even more preferably, dextrin having a DE of 18 to 8 can be used. Additionally, examples of the saccharide include sugar alcohol. Preferably, reducing sugar of monosaccharide or oligosaccharide, for example, reducing sugar of monosaccharide, disaccharide, trisaccharide, tetrasaccharide, or pentasaccharide, each can be used singly, or can be used as a mixture thereof. The content percentage of the saccharide in the batter of the present invention is not particularly limited and can be preferably 18 to 75% by mass. The mass ratio of the content amount of the saccharide to the content amount of water in the batter of the present invention (saccharide/water) is not particularly limited. The mass ratio can be preferably 0.3 to 4.5 and more preferably 0.6 to 4.0.

The cereal flour for use in the present invention is not particularly limited as long as the cereal flour is powdered cereal or a processed product thereof. Examples of the cereal flour include powders of tapioca, corn, potato, sweet potato, rice, mung bean, and wheat. Preferably, wheat flour or corn flour can be used. As the cereal flour, starch also can be suitably used. The starch for use in the present invention is not particularly limited as long as the starch has a starch structure. Examples thereof include starch obtained by purifying various raw materials such as tapioca, corn, potato, sweet potato, rice, mung bean, and wheat, and processed starch and pregelatinized starch obtained by chemically processing these starches as appropriate. The content amount of the starch in the batter of the present invention is not particularly limited and can be preferably 5 to 50% by mass.

According to another aspect of the present invention, provided is a batter for a deep-fried food product, comprising saccharide, cereal flour, and water, wherein the content percentage of the saccharide is 18 to 75% by mass, the content percentage of the cereal flour is 5 to 50% by mass, and the mass ratio of the content amount of the saccharide to the content amount of water (saccharide/water) is 0.3 to 4.5.

The batter of the present invention may contain other components in order to exert other effects, in addition to the essential components described above, within the range where the effects of the present invention are not compromised. Examples of the other components include a thickener, seasonings such as salt, sugar, and amino acid, a pigment such as p-carotene, a flavor, an acidulant, a pH adjusting agent, sugars, dietary fiber, and animal or vegetable protein raw material.

The processed food product for deep-frying of the present invention comprises an inner material of an intended deep-fried food product and a layer of the batter of the present invention located outside the inner material. In the present invention, the “processed food product for deep-frying” refers to a food product that has been processed for a deep-frying process and has not been subjected to the deep-frying process (pre-fried). Meanwhile, in the present invention, the “deep-fried food product” refers to a food product obtained by deep-frying the processed food product for deep-frying.

The processed food product for deep-frying of the present invention can be produced by a method including a step of batter processing, wherein the inner material of an intended deep-fried food product is processed with the batter of the present invention. It is possible to produce the processed food product for deep-frying of the present invention, for example, by attaching at least the batter of the present invention to the ingredient of an intended deep-fried food product, preferably, by coating the surface of the ingredient with the batter of the present invention.

Examples of such processed food products for deep-frying include pre-fried fries and the like, obtained by attaching the batter of the present invention and a coating raw material to an inner material, such as for croquettes, fried meat cakes, pork cutlets, deep-fried prawns, and deep-fried seafood; and pre-fried tempura, karaage, and the like, obtained by directly forming a coating layer using the batter of the present invention or attaching the batter of the present invention and a coating raw material to an inner material. As the coating raw material, bread crumbs are usually used. It is also possible to use coating raw materials other than bread crumbs. As substitutes for such bread crumbs, for example, crackers, corn flakes, puffed products mainly based on cereals obtained by extrusion, wheat gluten cakes, freeze-dried tofu, and soy pulp (okara) are known. These substitutes can be used as they are or after grated or crushed to an appropriate size. As the coating raw material, wheat flour, starches (such as corn starch), dried albumen, and the like also can be used.

For example, in the case of producing pre-fried chicken karaage as the processed food product for deep-frying of the present invention, the pre-fried chicken karaage can be obtained by attaching the batter of the present invention to the surface of an inner material of chicken cut into an appropriate size and seasoned. Here, before the batter of the present invention is attached to the inner material, a dusting powder such as potato starch may be attached to the surface of the inner material. Alternatively, after the batter of the present invention is attached to the inner material, a breader (e.g., a mixture of wheat flour, starch, and dried albumen, and the like) may be applied thereto.

For another example, in the case of producing an pre-fried croquette as the processed food product for deep-frying of the present invention, the pre-fried croquette can be obtained by kneading appropriately prepared vegetables such as potato and onion and meats such as beef or pork to form an inner material, attaching the batter of the present invention uniformly on the surface of the inner material obtained, and subsequently attaching bread crumbs thereto. Alternatively, the attaching step may be carried out by attaching primary bread crumbs (such as fine bread crumbs) uniformly to the inner material, then attaching the batter of the present invention thereto, and subsequently, attaching secondary bread crumbs thereto. Further, in such a method, pre-fried food product such as for fried prawns, pork cutlets, deep-fried seafood, and the like can be produced by changing the inner material by a raw material such as a prawn, pork, and seafood.

The processed food product for deep-frying of the present invention may be subjected to a deep-frying process immediately after production to obtain a deep-fried food product, or may be preserved by freezing or refrigeration, then subjected to a deep-frying process to obtain a deep-fried food product. The freezing or refrigeration method is not particularly limited, and the freezing or refrigeration may be conducted by a routine method. For example, in the case of freezing preservation, it is possible to use a method of freezing the processed food product for deep-frying in accordance with a freezing method such as an air-blast freezing method, semi-air-blast freezing method, or contact freezing method and then preserving the frozen food product at −18° C. or lower, or a method of freezing the processed food product for deep-frying by spraying liquefied nitrogen or liquefied carbon dioxide thereto and then preserving the frozen food product at −18° C. or lower. Particularly, as the freezing method, rapid freezing around −35° C. is desirable.

The deep-fried food product of the present invention comprises an inner material and a heated batter layer derived from the batter of the present invention located outside the inner material. Such a deep-fried food product can be produced by deep-frying the processed food product for deep-frying of the present invention. For example, a deep-frying process can be conducted by deep-frying the processed food product for deep-frying in edible fat and oil at 140 to 200° C. for 60 to 600 seconds, immediately after production or thereafter, through preservation by freezing or refrigeration.

The deep-fried food product thus produced may be served on the table immediately after production; may be preserved by freezing or refrigeration, then subjected to secondary cooking such as microwave cooking, and served on the table; or may be preserved at normal temperature and then served on the table. The method for freezing or refrigerating the deep-fried food product of the present invention is the same as the method described above for the processed food product for deep-frying of the present invention.

Additionally, the deep-fried food product of the present invention may be preserved at 20 to 75° C. after production. The method for preserving the deep-fried food product at the temperatures described above is not particularly limited. An example thereof is a method in which a heating device or warming device such as a hot warmer is used to preserve the deep-fried food product therein.

When the characteristic of the deep-fried food product of the present invention has been examined, it is known that the value of water activity of the coating layer contained in the deep-fried food product is in the range of 0.620 to 0.900 and preferably in the range of 0.620 to 0.860. This feature is not found in conventional products, and is considered to be a feature directly connected to retention of the crisp texture of the coating.

Therefore, according to another aspect of the present invention, provided is a deep-fried food product containing an inner material and a heated batter layer derived from a batter for a deep-fried food product located outside the inner material, wherein the value of water activity of the heated batter layer is 0.620 to 0.900 and preferably 0.620 to 0.860. The method for measuring the value of water activity of the coating layer is as mentioned above. This deep-fried food product also can be preserved by freezing.

Also, according to another aspect of the present invention, provided is a processed food product for deep-frying containing an inner material of an intended deep-fried food product and a layer of a batter for deep-fried food products located outside the inner material, wherein, in a deep-fried food product obtained by deep-frying the processed food product for deep-frying, the value of water activity of a coating layer containing a heated batter layer derived from the batter for deep-fried food products is 0.620 to 0.900 and preferably 0.620 to 0.860. The method for measuring the value of water activity of the coating layer is as mentioned above. This processed food product for deep-frying also can be preserved by freezing.

In addition, according to another aspect of the present invention, provided is a batter for deep-fried food products, wherein, in a deep-fried food product obtained by deep-frying a processed food product for deep-frying containing the batter for deep-fried food products, the value of water activity of a coating layer containing a heated batter layer derived from the batter for deep-fried food products is 0.620 to 0.900.

### EXAMPLES

The present invention will be described concretely with reference to the following examples, but the present invention is not intended to be limited to these examples.

### Example 1: Examination on Conditions Effective for Retaining Crisp Texture of Coating

### (1) Production of Batter Samples

Materials were introduced in accordance with the formulation table shown in the following Table 1 and mixed using a hand blender (manufactured by Braun GmbH, model: MQ500) for about 4 minutes so as to achieve a batter state.

TABLE 1
Mass (g) and percentage (% by mass) of raw material used in a batter of each test section

| | | Test section | | | | | |
|---|---|---|---|---|---|---|---|
| | | 1 | | Conventional art (1) | | Conventional art (2) | |
| | | Amount | | Amount | | Amount | |
| Raw material | | blended | | blended | | blended | |
| (general name) | Manufacturer | (g) | Percentage | (g) | Percentage | (g) | Percentage |
| Trehalose | Hayashibara Co., Ltd. | 40.0 | 33.3% | 20.0 | 10.0% | 20.0 | 6.7% |
| Potato starch | Matsutani Chemical | 48.0 | 40.0% | | 0.0% | | 0.0% |
| | Industry Co., Ltd. | | | | | | |
| Water | | 32.0 | 26.7% | 100.0 | 49.9% | 200.0 | 67.1% |
| Weak flour | Nisshin Seifun Group Inc. | | 0.0% | 1.5 | 0.7% | 30.0 | 10.1% |
| Wheat starch | Sanwa Starch Co., Ltd. | | 0.0% | 75.0 | 37.4% | | 0.0% |
| Waxy corn starch | Nihon Shokuhin Co., Ltd. | | 0.0% | | 0.0% | 25.0 | 8.4% |
| Dried albumen | Kewpie Egg Corporation | | 0.0% | 1.0 | 0.5% | | 0.0% |
| Baking powder | Okuno Chemical Industries | | 0.0% | 2.0 | 1.0% | 0.8 | 0.3% |
| | Co., Ltd. | | | | | | |
| Canola oil | The Nisshin OilliO Group, | | 0.0% | 1.0 | 0.5% | | 0.0% |
| | Ltd. | | | | | | |
| Corn flour | Nippon Flour Mills Co., Ltd. | | 0.0% | | 0.0% | 15.0 | 5.0% |
| Calcium carbonate | Wako Pure Chemical | | 0.0% | | 0.0% | 5.0 | 1.7% |
| | Corporation | | | | | | |
| Sucrose fatty acid | DKS Co. Ltd. | | 0.0% | | 0.0% | 1.0 | 0.3% |
| ester | | | | | | | |
| Succinic acid fatty | Riken Vitamin Co., Ltd. | | 0.0% | | 0.0% | 1.2 | 0.4% |
| acid ester | | | | | | | |
| Total | | 120.0 | 100.0% | 200.5 | 100.0% | 298.0 | 100.00% |
| Thickener for | | | | | | | |
| viscosity | | | | | | | |
| adjustment | | | | | | | |
| Welan gum | San-Ei Gen F.F.I., Inc. | 0.4 | 0.3% | | 0.0% | | 0.0% |
| Xanthan gum | DSP GOKYO FOOD & | | 0.0% | 2.0 | 1.0% | 3.0 | 1.0% |
| | CHEMICAL Co., Ltd. | | | | | | |

| | Test section | | | | | |
|---|---|---|---|---|---|---|
| | 2 | | 3 | | 4 | |
| | Amount | | Amount | | Amount | |
| Raw material | blended | | blended | | blended | |
| (general name) | (g) | Percentage | (g) | Percentage | (g) | Percentage |
| Trehalose | 30.0 | 27.3% | 20.0 | 20.0% | 10.0 | 11.1% |
| Potato starch | 48.0 | 43.6% | 48.0 | 48.0% | 48.0 | 53.3% |
| Water | 32.0 | 29.1% | 32.0 | 32.0% | 32.0 | 35.6% |
| Total | 110.0 | 100.0% | 100.0 | 100.0% | 90.0 | 100.0% |
| Thickener for | | | | | | |
| viscosity | | | | | | |
| adjustment | | | | | | |
| Welan gum | 0.4 | 0.4% | 0.4 | 0.4% | 0.2 | 0.2% |
| Xanthan gum | | 0.0% | | 0.0% | | 0.0% |

| | Test section | | | | | | | | | |
|---|---|---|---|---|---|---|---|---|---|---|
| | 5 | | 6 | | 7 | | 8 | | 9 | |
| | Amount | | Amount | | Amount | | Amount | | Amount | |
| Raw material | blended | | blended | | blended | | blended | | blended | |
| (general name) | (g) | Percentage | (g) | Percentage | (g) | Percentage | (g) | Percentage | (g) | Percentage |
| Trehalose | | 0.0% | 40.0 | 30.6% | 40.0 | 26.3% | 40.0 | 18.4% | 40.0 | 11.2% |
| Potato starch | 48.0 | 50.0% | 48.0 | 36.8% | 48.0 | 31.6% | 48.0 | 22.1% | 48.0 | 13.4% |
| Water | 40.0 | 50.0% | 42.6 | 32.6% | 64.0 | 42.1% | 129.0 | 59.4% | 270.0 | 75.4% |
| Total | 96.0 | 100.0% | 130.6 | 100.0% | 152.0 | 100.0% | 217.0 | 100.0% | 358.0 | 100.0% |
| Thickener for | | | | | | | | | | |
| viscosity | | | | | | | | | | |
| adjustment | | | | | | | | | | |
| Welan gum | 0.4 | 0.4% | 0.7 | 0.5% | 1.1 | 0.7% | 2.0 | 0.9% | | 0.0% |
| Xanthan gum | | 0.0% | | 0.0% | | 0.0% | | 0.0% | 6.0 | 1.7% |
| | Test section | | | | | | | | | |
| | 10 | | 11 | | 12 | | 13 | | 14 | |
| | Amount | | Amount | | Amount | | Amount | | Amount | |
| Raw material | blended | | blended | | blended | | blended | | blended | |
| (general name) | (g) | Percentage | (g) | Percentage | (g) | Percentage | (g) | Percentage | (g) | Percentage |
| Trehalose | | 0.0% | | 0.0% | 40.0 | 36.2% | 40.0 | 31.1% | 30.0 | 25.0% |
| Potato starch | 48.0 | 40.0% | 48.0 | 40.0% | 38.4 | 34.8% | 56.5 | 44.0% | 54.0 | 45.0% |
| Water | 32.0 | 26.7% | 32.0 | 26.7% | 32.0 | 29.0% | 32.0 | 24.9% | 36.0 | 30.0% |
| Glucose | 40.0 | 33.3% | | 0.0% | | 0.0% | | 0.0% | | 0.0% |
| Maltose | | 0.0% | 40.0 | 33.3% | | 0.0% | | 0.0% | | 0.0% |
| Total | 120.0 | 100.0% | 120.0 | 100.0% | 110.4 | 100.0% | 128.5 | 100.0% | 120.0 | 100.0% |
| Thickener for | | | | | | | | | | |
| viscosity | | | | | | | | | | |
| adjustment | | | | | | | | | | |
| Welan gum | 0.4 | 0.3% | 0.4 | 0.3% | 0.5 | 0.5% | | 0.0% | 0.8 | 0.7% |
| Xanthan gum | | 0.0% | | 0.0% | | 0.0% | | 0.0% | | 0.0% |
| | Test section | | | | | | | | | |
| | 15 | | 16 | | 17 | | 18 | | 19 | |
| | Amount | | Amount | | Amount | | Amount | | Amount | |
| Raw material | blended | | blended | | blended | | blended | | blended | |
| (general name) | (g) | Percentage | (g) | Percentage | (g) | Percentage | (g) | Percentage | (g) | Percentage |
| Trehalose | 30.0 | 25.0% | 30.0 | 25.0% | 40.0 | 33.3% | 40.0 | 33.3% | | 0.0% |
| Potato starch | 42.0 | 35.0% | 30.0 | 25.0% | | 0.0% | | 0.0% | 48.0 | 40.0% |
| Water | 48.0 | 40.0% | 60.0 | 50.0% | 32.0 | 26.7% | 32.0 | 26.7% | 32.0 | 26.7% |
| Weak flour | | 0.0% | | 0.0% | 48.0 | 40.0% | | 0.0% | | 0.0% |
| Corn flour | | 0.0% | | 0.0% | | 0.0% | 48.0 | 40.0% | | 0.0% |
| Sucrose | | 0.0% | | 0.0% | | 0.0% | | 0.0% | 40.0 | 33.3% |
| Total | 120.0 | 100.0% | 120.0 | 100.0% | 120.0 | 100.0% | 120.0 | 100.0% | 120.0 | 100.0% |
| Thickener for | | | | | | | | | | |
| viscosity | | | | | | | | | | |
| adjustment | | | | | | | | | | |
| Welan gum | | 0.0% | | 0.0% | | 0.0% | | 0.0% | 0.4 | 0.3% |
| Xanthan gum | 0.7 | 0.6% | 1.3 | 1.1% | | 0.0% | | 0.0% | | |
| | Test section | | | | | | | | | |
| | 20 | | 21 | | 22 | | 23 | | 24 | |
| | Amount | | Amount | | Amount | | Amount | | Amount | |
| Raw material | blended | | blended | | blended | | blended | | blended | |
| (general name) | (g) | Percentage | (g) | Percentage | (g) | Percentage | (g) | Percentage | (g) | Percentage |
| Trehalose | 39.8 | 39.8% | 44.8 | 44.8% | 20.0 | 20.0% | 20.0 | 20.0% | 20.0 | 20.0% |
| Potato starch | 36.1 | 36.1% | 33.1 | 33.1% | 10.0 | 10.0% | 20.0 | 20.0% | 40.0 | 40.0% |
| Water | 24.1 | 24.1% | 22.1 | 22.1% | 70.0 | 70.0% | 60.0 | 60.0% | 40.0 | 40.0% |
| Total | 100.0 | 100.0% | 100.0 | 100.0% | 100.0 | 100.0% | 100.0 | 100.0% | 100.0 | 100.0% |
| Thickener for | | | | | | | | | | |
| viscosity | | | | | | | | | | |
| adjustment | | | | | | | | | | |
| Welan gum | | 0.0% | | 0.0% | | 0.0% | | 0.0% | | 0.0% |
| Xanthan gum | | 0.0% | | 0.0% | | 0.0% | | 0.0% | | 0.0% |
| | Test section | | | | | | | | | |
| | 25 | | 26 | | 27 | | 28 | | 29 | |
| | Amount | | Amount | | Amount | | Amount | | Amount | |
| Raw material | blended | | blended | | blended | | blended | | blended | |
| (general name) | (g) | Percentage | (g) | Percentage | (g) | Percentage | (g) | Percentage | (g) | Percentage |
| Trehalose | 20.0 | 20.0% | 20.0 | 20.0% | 20.0 | 20.0% | 50.0 | 50.0% | 50.0 | 50.0% |
| Potato starch | 50.0 | 50.0% | 55.0 | 55.0% | 60.0 | 60.0% | 40.0 | 40.0% | 25.0 | 25.0% |
| Water | 30.0 | 30.0% | 25.0 | 25.0% | 20.0 | 20.0% | 10.0 | 10.0% | 25.0 | 25.0% |
| Total | 100.0 | 100.0% | 100.0 | 100.0% | 100.0 | 100.0% | 100.0 | 100.0% | 100.0 | 100.0% |
| Thickener for | | | | | | | | | | |
| viscosity | | | | | | | | | | |
| adjustment | | | | | | | | | | |
| Welan gum | | 0.0% | | 0.0% | | 0.0% | | 0.0% | | 0.0% |
| Xanthan gum | 0.3 | 0.3% | | 0.0% | | 0.0% | | 0.0% | 1.0 | 1.0% |

| Test section | | | | | |
|---|---|---|---|---|---|
| 30 | 31 | 32 | 33 | 34 | 35 |

| | Amount | | Amount | | Amount | | Amount | | Amount | | Amount | |
|---|---|---|---|---|---|---|---|---|---|---|---|---|
| Raw material | blended | | blended | | blended | | blended | | blended | | blended | |
| (general name) | (g) | Percentage | (g) | Percentage | (g) | Percentage | (g) | Percentage | (g) | Percentage | (g) | Percentage |
| Trehalose | 50.0 | 50.0% | 50.0 | 50.0% | 75.0 | 75.0% | 75.0 | 75.0% | 75.0 | 75.0% | 75.0 | 75.0% |
| Potato starch | 20.0 | 20.0% | 10.0 | 10.0% | 20.0 | 20.0% | 15.0 | 15.0% | 10.0 | 10.0% | 5.0 | 5.0% |
| Water | 30.0 | 30.0% | 40.0 | 40.0% | 5.0 | 5.0% | 10.0 | 10.0% | 15.0 | 15.0% | 20.0 | 20.0% |
| Total | 100.0 | 100.0% | 100.0 | 100.0% | 100.0 | 100.0% | 100.0 | 100.0% | 100.0 | 100.0% | 100.0 | 100.0% |
| Thickener for | | | | | | | | | | | | |
| viscosity | | | | | | | | | | | | |
| adjustment | | | | | | | | | | | | |
| Welan gum | | 0.0% | | 0.0% | | 0.0% | | 0.0% | | 0.0% | | 0.0% |
| Xanthan gum | | 0.0% | 1.2 | 1.2% | | 0.0% | | 0.0% | | 0.0% | 0.7 | 0.7% |

Test section

| | | |
|---|---|---|
| 36 | 37 | 38 |

| | Amount | | Amount | | Amount | |
|---|---|---|---|---|---|---|
| Raw material | blended | | blended | | blended | |
| (general name) | (g) | Percentage | (g) | Percentage | (g) | Percentage |
| Trehalose | 50.0 | 50.0% | 75.0 | 75.0% | 85.0 | 85.0% |
| Potato starch | | 0.0% | | 0.0% | | 0.0% |
| Water | 50.0 | 50.0% | 25.0 | 25.0% | 15.0 | 15.0% |
| Total | 100.0 | 100.0% | 100.0 | 100.0% | 100.0 | 100.0% |
| Thickener for | | | | | | |
| viscosity | | | | | | |
| adjustment | | | | | | |
| Welan gum | | 0.0% | | 0.0% | | 0.0% |
| Xanthan gum | | 0.0% | | 0.0% | | 0.0% |

| | | Test section | | | | | |
|---|---|---|---|---|---|---|---|
| | | 39 | | 40 | | 41 | |
| | | Amount | | Amount | | Amount | |
| Raw material | | blended | | blended | | blended | |
| (general name) | Manufacturer | (g) | Percentage | (g) | Percentage | (g) | Percentage |
| Trisaccharide | Mitsubishi-Chemical | 40.0 | 33.3% | | 0.0% | | 0.0% |
| (Oligotose (R)) | Foods Corporation | | | | | | |
| Tetrasaccharide | Hayashibara | | 0.0% | 40.0 | 33.3% | | 0.0% |
| (HALLODEX (R)) | Co., Ltd. | | | | | | |
| Pentasaccharide | B Food Science Co.. | | 0.0% | | 0.0% | 40.0 | 33.3% |
| (ESWEE 100) | Ltd. | | | | | | |
| Potato starch | | 48.0 | 40.0% | 48.0 | 40.0% | 48.0 | 40.0% |
| Water | | 32.0 | 26.7% | 32.0 | 26.7% | 32.0 | 26.7% |
| Total | | 120.0 | 100.0% | 120.0 | 100.0% | 120.0 | 100.0% |
| Thickener for | | | | | | | |
| viscosity | | | | | | | |
| adjustment | | | | | | | |
| Welan gum | | | 0.0% | | 0.0% | | 0.0% |
| Xanthan gum | | 1.0 | 0.8% | 1.0 | 0.8% | 1.0 | 0.8% |

| | | Test section | | | | | | | |
|---|---|---|---|---|---|---|---|---|---|
| | | 42 | | 43 | | 44 | | 45 | |
| | | Amount | | Amount | | Amount | | Amount | |
| Raw material | | blended | | blended | | blended | | blended | |
| (general name) | Manufacturer | (g) | Percentage | (g) | Percentage | (g) | Percentage | (g) | Percentage |
| Trehalose | Hayashibara | | 0.0% | | 0.0% | 30.0 | 30.0% | 35.0 | 35.0% |
| | Co., Ltd. | | | | | | | | |
| Dextrin: DE8 | Matsutani Chemical | 40.0 | 41.6% | | 0.0% | | 0.0% | | 0.0% |
| | Industry Co., Ltd. | | | | | | | | |
| Dextrin: DE18 | Matsutani Chemical | | 0.0% | 40.0 | 33.3% | | 0.0% | | 0.0% |
| | Industry Co., Ltd. | | | | | | | | |
| Potato starch | | 24.0 | 25.0% | 48.0 | 40.0% | 5.0 | 5.0% | 5.0 | 5.0% |
| Water | | 32.0 | 33.0% | 32.0 | 26.7% | 65.0 | 65.0% | 60.0 | 60.0% |
| Total | | 96.0 | 100.0% | 120.0 | 100.0% | 100.0 | 100.0% | 100.0 | 100.0% |
| Thickener for | | | | | | | | | |
| viscosity | | | | | | | | | |
| adjustment | | | | | | | | | |
| Welan gum | | | 0.0% | | 0.0% | | 0.0% | | 0.0% |
| Xanthan gum | | 0.1 | 0.1% | 0.3 | 0.3% | 1.5 | 1.5% | 1.5 | 1.5% |

Test section
46

| | | Amount | |
|---|---|---|---|
| Raw material | | blended | |
| (general name) | Manufacturer | (g) | Percentage |
| Potato starch | | 25.0 | 25.0% |
| Dextrin: DE4 | Matsutani Chemical | 33.3 | 33.3% |
| | Industry Co., Ltd. | | |
| Water | | 41.7 | 41.7% |
| Total | | 100.0 | 100.0% |
| Thickener for | | | |
| viscosity | | | |
| adjustment | | | |
| Welan gum | | 0.0 | 0.0% |
| Xanthan gum | | 0.0 | 0.0% |

| | | Test section | | | |
|---|---|---|---|---|---|
| | | 47 | | 48 | |
| | | Amount | | Amount | |
| Raw material | | blended | | blended | |
| (general name) | Manufacturer | (g) | Percentage | (g) | Percentage |
| Sugar alcohol (sorbitol) | B Food Science | 40.0 | 33.3% | 0.00 | 0.0% |
| | Co., Ltd. | | | | |
| Sugar alcohol (MU45) | UENO FOOD | 0.00 | 0.0% | 52.20 | 47.5% |
| | TECHNO | | | | |
| | INDUSTRY, LTD. | | | | |
| Potato starch | | 48.00 | 40.0% | 44.00 | 40.1% |
| Water | | 32.00 | 26.7% | 13.60 | 12.4% |
| Total | | 120.0 | 100.0% | 110.0 | 100.0% |
| Thickener for | | | | | |
| viscosity | | | | | |
| adjustment | | | | | |
| Xanthan gum | | 0.400 | 0.3% | 0.400 | 0.4% |

MU45: a sugar alcohol composition mainly based on reducing sugars of monosaccharide and disaccharide (solid content 70%)

Each sample was evaluated whether the sample had necessary flowability as a batter.

### (2) Production of Chicken Karaage Using Batter Samples

Among the batter samples obtained, batter samples having necessary flowability as a batter were used to produce chicken karraage in accordance with the following procedure.

1. Chicken as raw material meat was cut into pieces each having a mass of 32±2 g.
2. A seasoning liquid (6.1% salt, 3.0% a phosphate (phosphate No. 35; manufactured by Daiichi Kasei Co., Ltd.), and 90.9% water) was weighed out such that the seasoning liquid was 16.5 g per 100 g of the raw material meat, and introduced with the meat into a PE bag.
3. The opening of the PE bag was sealed.
4. The meat in the PE bag was massaged using a tumbler (vacuum massage tumbler model MG-40) at 12 rpm for 30 minutes under normal pressure in a chilling temperature zone.
5. The meat tumbled was placed in a bowl, and potato starch (Stabirose 1000; manufactured by Matsutani Chemical Industry Co., Ltd.) was introduced in the bowl such that potato starch was 6.5 g per 100 g of the raw material meat, and mixed with the meat.
6. Additionally, the batter sample was introduced into the bowl such that the batter sample was 27.0 g per 100 g of the raw material meat, and mixed with the meat.
7. Further, each piece was dusted with a breader containing 88.9% wheat flour (Violet; manufactured by Nisshin Seifun Group Inc.), 7.8% corn starch (corn starch Y; manufactured by Sanwa Starch Co., Ltd.), and 3.3% dried albumen (dried albumen K type; manufactured by Kewpie Egg Corporation) such that the breader was 26.0 g per 100 g of the raw material meat.
8. The meat obtained having the coating was deep-fried twice. In the first deep-frying, the meat was deep-fried at 165° C. for 2 minutes 15 seconds and then left to stand at normal temperature for 3 minutes. In the second deep-frying, the meat was deep-fried at 165° C. for 2 minutes 15 seconds.
9. The chicken karaage obtained was frozen in a freezer at about −35° C.

### (3) Preparation of Chicken Karaage for Tasting

The frozen chicken karaage obtained in the above (2) was deep-fried at 175° C. for 7 minutes. The chicken karaage after deep-frying was allowed to cool for about 5 minutes, four pieces were placed in a food pack SA-20 manufactured by FP Corporation (a pack made of a biaxially-oriented polystyrene sheet having a transparent lid, 130 mm in length×201 mm in width×49 mm in height), covered with the lid, and left to stand at normal temperature for about 3 hours. The four preserved sample pieces were placed on a plate, introduced in a microwave oven, heated with an output of 600 W for 1 minute 10 seconds, and subjected to a sensory evaluation.

### (4) Sensory Evaluation

The chicken karaage samples produced in the above (3) were sensory-evaluated by three specialized panel members. Evaluation items and evaluation criteria were as follows. For each item, a product immediately after deep-frying (immediately after deep-frying in the above (3)) was set at a score of 5 out of 5.

### (i) Crispness of Coating:

1: No crispness-(3 or higher: acceptable)-5: Having crispness

### (ii) Pull of Coating (Easiness of Biting Off):

1: difficult to bite off-(3 or higher: acceptable)-5: easy to bite off

(iii) Softening of Coating (Retaining Hardness of Coating):

1: softened-(3 or higher: acceptable)-5: not softened

### (iv) Comprehensive Evaluation:

Excellent: The quality of the coating is fully satisfactory.

Good: The quality of the coating is satisfactory.

Poor: The quality of the coating is unacceptable.

### (5) Measurement of Water Activity of Coating Layer

The chicken karaage immediately after deep-frying in the above (3) was measured for the value of water activity of the coating layer by the following procedure.

1. The chicken karaage was allowed to slightly cool while left at normal temperature. Then, the coating portion (the portion other than the inner material) was removed.
2. The coating removed was cut into small pieces for uniformity.
3. 3 to 3.5 g of the sample was placed in a Petri dish, and set in a water activity measurement system manufactured by Rotronic AG (Rotronic hygrolab), and the value of water activity was measured.

### (6) Results and Discussion

For each sample, the results of the sensory evaluation and the results of the measurement for water activity are shown in the following Table 2.

TABLE 2
Sensory evaluation results and water activity of coating layer of samples deep-fried, then placed in pack having transparent
lid, covered with the lid, left to stand at normal temperature for 3 hours, and heated in microwave oven

| | Saccha- | Cereal | | | | | | | | | Stan- |
|---|---|---|---|---|---|---|---|---|---|---|---|
| | ride | flour | Water | Saccha- | | | | Retaining | Compre- | Water | dard |
| Test | percent- | percent- | percent- | ride/ | Flow- | Crispness | Pull of | hardness | hensive | activity | devi- |
| section | age | age | age | water | ability | of coating | coating | of coating | evaluation | (AW) | ation |
| 1 | 33.3 | 40.0 | 26.7 | 1.250 | Good | 4.0 | 4.0 | 4.0 | Excellent | 0.721 | 0.050 |
| Conven- | 10.0 | 38.1 | 49.9 | 0.200 | Good | 2.2 | 2.3 | 4.0 | Poor | 0.961 | 0.006 |
| tional | | | | | | | | | | | |
| art (1) | | | | | | | | | | | |
| Conven- | 6.7 | 23.5 | 67.1 | 0.286 | Good | 2.4 | 2.7 | 4.0 | Poor | 0.963 | 0.005 |
| tional | | | | | | | | | | | |
| art (2) | | | | | | | | | | | |
| 2 | 27.3 | 43.6 | 29.1 | 0.938 | Good | 4.0 | 4.0 | 4.0 | Excellent | | |
| 3 | 20.0 | 48.0 | 32.0 | 0.625 | Good | 3.5 | 3.3 | 4.0 | Good | 0.868 | 0.013 |
| 4 | 11.1 | 53.3 | 35.6 | 0.311 | Good | 2.2 | 2.0 | 2.5 | Poor | 0.945 | 0.010 |
| 5 | 0.0 | 50.0 | 50.0 | 0.000 | Good | 2.0 | 2.3 | 2.8 | Poor | 0.972 | 0.010 |
| 6 | 30.6 | 36.8 | 32.6 | 0.938 | Good | 4.0 | 3.8 | 4.3 | Excellent | | |
| 7 | 26.3 | 31.6 | 42.1 | 0.625 | Good | 3.7 | 3.5 | 4.0 | Excellent | | |
| 8 | 18.4 | 22.1 | 59.4 | 0.311 | Good | 3.2 | 3.0 | 3.5 | Good | 0.878 | 0.008 |
| 9 | 11.2 | 13.4 | 75.4 | 0.178 | Good | 2.9 | 3.5 | 3.5 | Poor | 0.943 | 0.011 |

| | | | Saccha- | Cereal | | | | | | | | | Stan- |
|---|---|---|---|---|---|---|---|---|---|---|---|---|---|
| | | | ride | flour | Water | Saccha- | | | | Retaining | Compre- | Water | dard |
| Test | Test | | percent- | percent- | percent- | ride/ | Flow- | Crispness | Pull of | hardness | hensive | activity | devi- |
| section | purpose | Test outline | age | age | age | water | ability | of coating | coating | of coating | evaluation | (AW) | ation |
| 10 | Type of | Monosac- | 33.3 | 40.0 | 26.7 | 1.250 | Good | 3.7 | 4.0 | 4.0 | Excellent | 0.813 | 0.016 |
| | saccharide | charide | | | | | | | | | | | |
| | | (glucose) | | | | | | | | | | | |
| 11 | | Disac- | 33.3 | 40.0 | 26.7 | 1.250 | Good | 3.3 | 3.3 | 3.5 | Good | | |
| | | charide | | | | | | | | | | | |
| | | (maltose) | | | | | | | | | | | |
| 19 | | Disac- | 33.3 | 40.0 | 26.7 | 1.250 | Good | 3.8 | 4.2 | 3.7 | Excellent | 0.795 | 0.049 |
| | | charide | | | | | | | | | | | |
| | | (sucrose) | | | | | | | | | | | |
| 39 | | Trisac- | 33.3 | 40.0 | 26.7 | 1.250 | Good | 4.1 | 4.0 | 3.8 | Excellent | | |
| | | charide | | | | | | | | | | | |
| | | (Oligotose | | | | | | | | | | | |
| | | (R)) | | | | | | | | | | | |
| 40 | | Tetrasac- | 33.3 | 40.0 | 26.7 | 1.250 | Good | 3.9 | 4.0 | 4.0 | Excellent | | |
| | | charide | | | | | | | | | | | |
| | | (HALLODEX | | | | | | | | | | | |
| | | (R)) | | | | | | | | | | | |
| 41 | | Pentasac- | 33.3 | 40.0 | 26.7 | 1.250 | Good | 3.8 | 3.7 | 3.4 | Excellent | 0.778 | 0.021 |
| | | charide, | | | | | | | | | | | |
| | | *reduced | | | | | | | | | | | |
| | | sugar syrup | | | | | | | | | | | |
| | | (ESWEE 100) | | | | | | | | | | | |
| 42 | | Dextrin: | 41.6 | 25.0 | 33.0 | 1.261 | Good | 3.8 | 3.7 | 3.9 | Excellent | 0.804 | 0.021 |
| | | DE8 | | | | | | | | | | | |
| 43 | | Dextrin: | 33.3 | 40.0 | 26.7 | 1.150 | Good | 3.9 | 4.0 | 3.8 | Excellent | 0.786 | 0.010 |
| | | DE18 | | | | | | | | | | | |
| 46 | | Dextrin: DE4 | 33.3 | 25.0 | 41.7 | 0.799 | Good | 3.6 | 3.3 | 3.8 | Excellent | 0.782 | 0.041 |
| 47 | | Sugar | 33.3 | 40.0 | 26.7 | 1.250 | Good | 3.3 | 3.3 | 3.5 | Good | 0.692 | 0.084 |
| | | alcohol | | | | | | | | | | | |
| | | (Sorbitol) | | | | | | | | | | | |
| 48 | | Sugar | 33.3 | 40.1 | 26.7 | 1.247 | Good | 3.5 | 3.7 | 3.5 | Good | 0.767 | 0.029 |
| | | alcohol | | | | | | | | | | | |
| | | (MU45) | | | | | | | | | | | |
| 12 | | | 36.2 | 34.8 | 29.0 | 1.248 | Good | 3.3 | 3.5 | 3.5 | Good | | |
| 13 | | | 31.1 | 44.0 | 24.9 | 1.249 | Good | 3.5 | 3.8 | 4.5 | Good | | |

| | Saccha- | Cereal | | | | | | | | | Stan- |
|---|---|---|---|---|---|---|---|---|---|---|---|
| | ride | flour | Water | Saccha- | | | | Retaining | Compre- | Water | dard |
| Test | percent- | percent- | percent- | ride/ | Flow- | Crispness | Pull of | hardness | hensive | activity | devi- |
| section | age | age | age | water | ability | of coating | coating | of coating | evaluation | (AW) | ation |
| 14 | 25.0 | 45.0 | 30.0 | 0.833 | Good | 4.0 | 4.0 | 4.3 | Excellent | 0.860 | 0.007 |
| 15 | 25.0 | 35.0 | 40.0 | 0.625 | Good | 3.5 | 3.0 | 4.5 | Good | | |
| 16 | 25.0 | 25.0 | 50.0 | 0.500 | Good | 3.3 | 3.5 | 4.0 | Good | | |
| 17 | 33.3 | 40.0 | 26.7 | 1.250 | Good | 3.5 | 3.5 | 3.8 | Good | 0.813 | 0.022 |
| 18 | 33.3 | 40.0 | 26.7 | 1.250 | Good | 3.7 | 3.8 | 4.0 | Excellent | | |
| 20 | 39.8 | 36.1 | 24.1 | 1.651 | Good | | | | | | |
| 21 | 44.8 | 33.1 | 22.1 | 2.027 | Good | | | | | | |

| | Saccha- | Cereal | | | | | | | | | Stan- |
|---|---|---|---|---|---|---|---|---|---|---|---|
| | ride | flour | Water | Saccha- | | | | Retaining | Compre- | Water | dard |
| Test | percent- | percent- | percent- | ride/ | Flow- | Crispness | Pull of | hardness | hensive | activity | devi- |
| section | age | age | age | water | ability | of coating | coating | of coating | evaluation | (AW) | ation |
| 22 | 20.0 | 10.0 | 70.0 | 0.286 | Excellent | 2.5 | 3.8 | 2.8 | Poor | 0.941 | 0.008 |
| 23 | 20.0 | 20.0 | 60.0 | 0.333 | Excellent | 3.5 | 3.8 | 3.8 | Good | 0.818 | 0.017 |
| 24 | 20.0 | 40.0 | 40.0 | 0.500 | Excellent | 3 6 | 3.8 | 3.9 | Good | 0.809 | 0.019 |
| 25 | 20.0 | 50.0 | 30.0 | 0.667 | Excellent | 3.9 | 4.0 | 4.0 | Excellent | 0.848 | 0.025 |
| 26 | 20.0 | 55.0 | 25.0 | 0.800 | Poor | | | | | | |
| 27 | 20.0 | 60.0 | 20.0 | 1.000 | Poor | | | | | | |
| 28 | 50.0 | 40.0 | 10.0 | 5.000 | Poor | | | | | | |
| 29 | 50.0 | 25.0 | 25.0 | 2.000 | Excellent | 4.1 | 4.0 | 3.9 | Excellent | 0.829 | 0.021 |
| 30 | 50.0 | 20.0 | 30.0 | 1.667 | Excellent | | | | | | |
| 31 | 50.0 | 10.0 | 40.0 | 1.250 | Excellent | 3.9 | 4.3 | 3.8 | Excellent | 0.814 | 0.024 |
| 32 | 75.0 | 20.0 | 5.0 | 15.00 | Poor | | | | | | |
| 33 | 75.0 | 15.0 | 10.0 | 7.500 | Poor | | | | | | |
| 34 | 75.0 | 10.0 | 15.0 | 5.000 | Poor | | | | | | |
| 35 | 75.0 | 5.0 | 20.0 | 3.750 | Excellent | 4.4 | 4.3 | 4.0 | Excellent | 0.706 | 0.089 |
| 36 | 50.0 | 0.0 | 50.0 | 1.000 | Excellent | | | | | | |
| 37 | 75.0 | 0.0 | 25.0 | 3.000 | Excellent | | | | | | |
| 38 | 85.0 | 0.0 | 15.0 | 5.667 | Poor | | | | | | |
| | Saccha- | Cereal | | | | | | | | | Stan- |
| | ride | flour | Water | Saccha- | | | | Retaining | Compre- | Water | dard |
| Test | percent- | percent- | percent- | ride/ | Flow- | Crispness | Pull of | hardness | hensive | activity | devi- |
| section | age | age | age | water | ability | of coating | coating | of coating | evaluation | (AW) | ation |
| 44 | 30.0 | 5.0 | 65.0 | 0.462 | Excellent | 3.4 | 3.3 | 3.5 | Good | 0.826 | 0.008 |
| 45 | 35.0 | 5.0 | 60.0 | 0.583 | Excellent | 3.3 | 3.1 | 3.4 | Good | 0.809 | 0.019 |

(Note)
The percentages of saccharide, cereal, and water are each expressed in % by mass. Saccharide/water is expressed in a mass ratio. Flowability refers to flowability necessary for a batter.

As clearly seen from Table 2, in the samples exhibiting satisfactory evaluation results in the sensory evaluation, the value of water activity of the coating layer was 0.900 or less. In the samples exhibiting a value of 0.860 or less, the evaluation results were more satisfactory.

Additionally, in the samples exhibiting satisfactory evaluation results in the sensory evaluation, the content percentage of the saccharide in the batter was 18 to 75% by mass, and the content percentage of the cereal flour was 5 to 50% by mass. Further, in the samples exhibiting satisfactory evaluation results in the sensory evaluation, the mass ratio of the content amount of the saccharide to the content amount of water in the batter (saccharide/water) was 0.3 to 4.5. In the samples exhibiting 0.6 to 4.0, the evaluation results were more satisfactory.

It was also found that, as the saccharide, various saccharides such as monosaccharide, disaccharide, trisaccharide, tetrasaccharide, pentasaccharide, dextrin, and sugar alcohol can be used (test sections 1, 10, 11, 19, 39 to 43, and 46 to 48). Also as for the cereal flour, it was found that various cereal flours such as starch, wheat flour, and corn flour can be used (test sections 1, 17, and 18).

(7) Confirmation of the Effect in Fries in which Bread Crumbs are Used as Coating Raw Material

Croquettes were produced as follows. First, as a batter sample, 40.00 g of trehalose, 50.00 g of water, 48.00 g of potato starch, and 0.50 g of xanthan gum were mixed using a hand blender (manufactured by Braun GmbH, model: MQ500) to obtain a batter of the present example. Separately from this batter, as a batter sample of a negative control, 75.00 g of water, 40.00 g of potato starch, and 0.44 g of xanthan gum were mixed using a hand blender (manufactured by Braun GmbH, model: MQ500) to obtain a batter.

Meanwhile, as a pretreated material, onion (finely chopped into 4 mm pieces) at 16.1% by mass, salt at 2.4% by mass, black pepper at 0.3% by mass, beef mince at 64.5% by mass, soy sauce at 7.3% by mass, sweet cooking sake at 3.0% by mass, and caster sugar at 6.4% by mass were stir-fried together. The pretreated material obtained at 28.4% by mass, mashed potato at 69.6% by mass, and fine bread crumbs at 2.0% by mass were mixed and shaped to obtain the inner material of croquettes.

To the surface of 52.00 g of the inner material obtained, 0.70 g of fine bread crumbs, as a dusting powder, was applied. Then, the surface was coated with 15.0 g of each batter sample, and then, 12.0 g of semi-moist bread crumbs (14 mm) was attached to the surface. The pre-fried croquettes obtained were rapidly frozen in a freezer at about −35° C.

The frozen pre-fried croquette prepared as described above was deep-fried at 175° C. for 6 minutes 30 seconds. The fried croquette after deep-frying was allowed to cool for about 5 minutes, two pieces were placed in a food pack SA-20 manufactured by FP Corporation (a pack made of a biaxially-oriented polystyrene sheet having a transparent lid, 130 mm in length×201 mm in width×49 mm in height), the lid was closed, and the pieces were left to stand at normal temperature for about 3 hours. The two preserved sample pieces were placed on a plate, introduced in a microwave oven, heated with an output of 600 W for 1 minute 10 seconds, and subjected to the same sensory evaluation as described above.

The results are shown in the following Table 3.

TABLE 3
Confirmation of effect in croquettes (deep-fried foods in which bread crumbs are used)

| | | Cereal | | | | | | Retaining | |
|---|---|---|---|---|---|---|---|---|---|
| | Saccharide | flour | Water | Saccharide/ | | Crispness | Pull of | hardness | Comprehensive |
| Test section | percentage | percentage | percentage | water | Flowability | of coating | coating | of coating | evaluation |
| Negative | 0.0 | 34.7 | 65.0 | 0.000 | Excellent | 2.5 | 1.8 | 2.5 | Poor |
| control (no | | | | | | | | | |
| saccharide) | | | | | | | | | |
| Croquette | 28.9 | 34.7 | 36.1 | 0.801 | Excellent | 3.5 | 3.5 | 3.3 | Good |
| example | | | | | | | | | |

(Note)
The percentages of saccharide, cereal, and water are each expressed in % by mass. Saccharide/water is expressed in a mass ratio. Flowability refers to flowability necessary for a batter.

As clearly seen from Table 3, from the comparison between the sample of the present example and the negative control sample without blending a saccharide in the batter, an effect comparable to the effect demonstrated for the chicken karaage was also confirmed even in the fries prepared using bread crumbs such as croquettes.

### (8) Sensory Evaluation of Appearance of Coating

Some of the samples evaluated as satisfactory in the above (6) were sensory-evaluated for the appearance of the coating (after preservation for 3 hours in a pack) by three specialized panel members. Evaluation criteria were 1: wet to 5: moderately dry, and a product immediately after deep-frying (immediately after deep-frying in the above (3)) was set at a score of 5 out of 5. As the negative control, the sample of the test section 5 (no saccharide) was used.

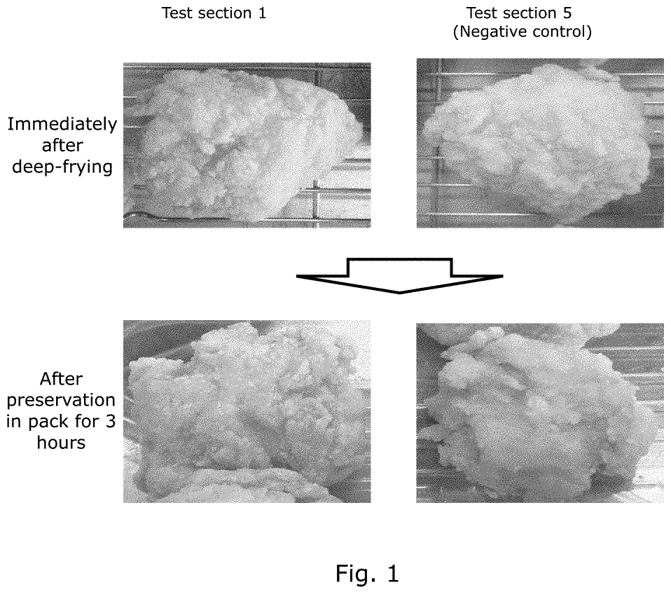

Photographs in FIG. 1 shows appearance, for comparison, of a sample of test section 1 and a sample of test section 5 as a negative control each at immediately after deep-frying and at 3-hour preservation in a package thereafter. According to FIG. 1, it can be seen that both samples, immediately after deep-frying, exhibit a moderately dry appearance, which is favorable. In contrast, after preservation for 3 hours in a pack, the sample of test section 1 (sensory evaluation result of the coating appearance: 4.3) retains the appearance immediately after deep-frying, whereas, in the sample of test section 5 (sensory evaluation result of the coating appearance: 3.0) as the negative control, approximately a half area of the coating was moist, and its appearance could not be said to be favorable.

Next, the results of the sensory evaluation of the coating appearance are shown in the following Table 4.

TABLE 4
Sensory evaluation results of coating appearance of samples deep-fried, then placed in pack having transparent
lid, covered with the lid, left to stand at normal temperature for 3 hours, and heated in microwave oven

| | | Cereal | | | | |
|---|---|---|---|---|---|---|
| Test | Saccharide | flour | Water | Saccharide/ | Appearance | Comprehensive |
| section | percentage | percentage | percentage | water | of coating | evaluation |
| 1 | 33.3 | 40.0 | 26.7 | 1.250 | 4.3 | Excellent |
| 2 | 27.3 | 43.6 | 29.1 | 0.938 | 4.3 | Excellent |
| 3 | 20.0 | 48.0 | 32.0 | 0.625 | 4.3 | Good |
| 5 (Negative | 0.0 | 50.0 | 50.0 | 0.000 | 3.0 | Poor |
| control) | | | | | | |
| 6 | 30.6 | 36.8 | 32.6 | 0.938 | 4.3 | Excellent |
| 7 | 26.3 | 31.6 | 42.1 | 0.625 | 4.3 | Excellent |
| 8 | 18.4 | 22.1 | 59.4 | 0.311 | 4.0 | Good |

| | | | | Cereal | | | | |
|---|---|---|---|---|---|---|---|---|
| Test | Test | | Saccharide | flour | Water | Saccharide/ | Appearance | Comprehensive |
| section | purpose | Test outline | percentage | percentage | percentage | water | of coating | evaluation |
| 10 | Type of | Monosaccharide | 33.3 | 40.0 | 26.7 | 1.250 | 4.0 | Excellent |
| | saccharide | (glucose) | | | | | | |
| 11 | | Disaccharide | 33.3 | 40.0 | 26.7 | 1.250 | 4.0 | Good |
| | | (maltose) | | | | | | |
| 19 | | Disaccharide | 33.3 | 40.0 | 26.7 | 1.250 | 4.0 | Excellent |
| | | (sucrose) | | | | | | |
| 39 | | Trisaccharide | 33.3 | 40.0 | 26.7 | 1.250 | 3.8 | Excellent |
| | | (Oligotose | | | | | | |
| | | (R)) | | | | | | |
| 40 | | Tetrasaccharide | 33.3 | 40.0 | 26.7 | 1.250 | 3.8 | Excellent |
| | | (HALLODEX | | | | | | |
| | | (R)) | | | | | | |
| 41 | | Pentasaccharide, | 33.3 | 40.0 | 26.7 | 1.250 | 3.8 | Excellent |
| | | *reduced | | | | | | |
| | | sugar syrup | | | | | | |
| | | (ESWEE 100) | | | | | | |
| 42 | | Dextrin: | 41.6 | 25.0 | 33.0 | 1.261 | 3.7 | Excellent |
| | | DE8 | | | | | | |
| 43 | | Dextrin: | 33.3 | 40.0 | 26.7 | 1.250 | 3.9 | Excellent |
| | | DE18 | | | | | | |
| 46 | | Dextrin: DE4 | 33.3 | 25.0 | 41.7 | 0.799 | 3.8 | Excellent |
| 47 | | Sugar alcohol | 33.3 | 40.0 | 26.7 | 1.250 | 4.0 | Good |
| | | (Sorbitol) | | | | | | |
| 48 | | Sugar alcohol | 33.3 | 40.1 | 26.7 | 1.247 | 4.0 | Good |
| | | (MU45) | | | | | | |
| 12 | | | 36.2 | 34.8 | 29.0 | 1.248 | 3.8 | Good |
| 13 | | | 31.1 | 44.0 | 24.9 | 1.249 | 3.5 | Good |

| | | Cereal | | | | |
|---|---|---|---|---|---|---|
| Test | Saccharide | flour | Water | Saccharide/ | Appearance | Comprehensive |
| section | percentage | percentage | percentage | water | of coating | evaluation |
| 14 | 25.0 | 45.0 | 30.0 | 0.833 | 4.3 | Excellent |
| 15 | 25.0 | 35.0 | 40.0 | 0.625 | 4.0 | Good |
| 16 | 25.0 | 25.0 | 50.0 | 0.500 | 4.0 | Good |
| 17 | 33.3 | 40.0 | 26.7 | 1.250 | 4.2 | Good |
| 18 | 33.3 | 40.0 | 26.7 | 1.250 | 4.0 | Excellent |
| 23 | 20.0 | 20.0 | 60.0 | 0.333 | 4.0 | Good |
| 24 | 20.0 | 40.0 | 40.0 | 0.500 | 4.0 | Good |
| 25 | 20.0 | 50.0 | 30.0 | 0.667 | 4.0 | Excellent |
| 29 | 50.0 | 25.0 | 25.0 | 2.000 | 4.0 | Excellent |
| 31 | 50.0 | 10.0 | 40.0 | 1.250 | 4.0 | Excellent |
| 35 | 75.0 | 5.0 | 20.0 | 3.750 | 4.0 | Excellent |
| 44 | 30.0 | 5.0 | 65.0 | 0.462 | 4.1 | Good |
| 45 | 35.0 | 5.0 | 60.0 | 0.583 | 4.4 | Good |

(Note)
The percentages of saccharide, cereal, and water are each expressed in % by mass. Saccharide/water is expressed in a mass ratio.

As clearly seen from Table 4, the samples evaluated as satisfactory in the above (6) had a satisfactory appearance of the coating even after preservation for 3 hours after deep-frying.

1. A batter for a deep-fried food product comprising saccharide, cereal flour, and water, wherein
in a deep-fried food product obtained by deep-frying a processed food product for deep-frying containing the batter for the deep-fried food product, the value of water activity of a coating layer containing a heated batter layer derived from the batter for the deep-fried food product is 0.620 to 0.900.

2. The batter for a deep-fried food product according to claim 1, wherein a content percentage of the saccharide is 18 to 75% by mass, a content percentage of the cereal flour is 5 to 50% by mass, and a mass ratio of a content amount of the saccharide to a content amount of the water (saccharide/water) is 0.3 to 4.5.

3. The batter for a deep-fried food product according to claim 1, wherein the saccharide is selected from the group consisting of monosaccharide, disaccharide, trisaccharide, tetrasaccharide, pentasaccharide, sugar alcohol, and dextrin.

4. The batter for a deep-fried food product according to claim 1, wherein the saccharide is selected from the group consisting of monosaccharide, disaccharide, trisaccharide, tetrasaccharide, pentasaccharide, and dextrin.

5. The batter for a deep-fried food product according to claim 1, wherein the cereal flour is selected from the group consisting of starch, wheat flour, and corn flour.

6. A processed food product for deep-frying comprising an inner material of an intended deep-fried food product, and a layer of the batter for the deep-fried food product according to claim 1 located outside the inner material.

7. The processed food product for deep-frying according to claim 6, wherein the processed food product is frozen.

8. A method for producing a processed food product for deep-frying, comprising a step of batter processing, wherein the inner material of an intended deep-fried food product is processed with the batter for the deep-fried food product according to claim 1.

9. The method according to claim 8, further comprising a step of freezing, wherein the freezing step is conducted after the step batter processing.

10. A deep-fried food product comprising an inner material, and a heated batter layer derived from the batter for the deep-fried food product according to claim 1 located outside the inner material.

11. The deep-fried food product according to claim 10, wherein the deep-fried food product is frozen.

12. A method for producing a deep-fried food product, comprising a step of deep-frying the processed food product for deep-frying according to claim 6.

13. A method for producing a deep-fried food product, comprising a step of producing a processed food product for deep-frying by the method according to claim 8, and a step of deep-frying the processed food product for deep-frying.

14. The method according to claim 12, further comprising a step of freezing, wherein the freezing step is conducted after the step of deep-frying.

15. A batter for a deep-fried food product, wherein, in a deep-fried food product obtained by deep-frying a processed food product for deep-frying containing the batter for the deep-fried food product, the value of water activity of a coating layer containing a heated batter layer derived from the batter for the deep-fried food product is 0.620 to 0.900.

16. A processed food product for deep-frying comprising an inner material of an intended deep-fried food product and a layer of a batter for the deep-fried food product located outside the inner material, wherein, in the deep-fried food product obtained by deep-frying the processed food product for deep-frying, the value of water activity of a coating layer containing a heated batter layer derived from the batter for the deep-fried food product is 0.620 to 0.900.

17. A deep-fried food product comprising an inner material and a heated batter layer derived from a batter for the deep-fried food product located outside the inner material, wherein the value of water activity of a coating layer containing the heated batter layer is 0.620 to 0.900.
